(19) United States
(12) Patent Application Publication
(10) Pub. No.: US 2018/0062873 A1
(43) Pub. Date: Mar. 1, 2018

(54) LORA MOBILE UNIT FOR ALLOWING A MOBILE DEVICE TO DIRECTLY ACCESS LORA INFORMATION PACKETS AND DATA TRANSMISSION METHOD OF SAME

(71) Applicant: ADLINK TECHNOLOGY INC., New Taipei (TW)

(72) Inventors: Pai-Chou CHIANG, New Taipei (TW); Yu-Yun LIU, New Taipei (TW); Feng-Chi CHUANG, New Taipei (TW); Pei-Chia HSIEH, New Taipei (TW)

(21) Appl. No.: 15/499,325

(22) Filed: Apr. 27, 2017

(30) Foreign Application Priority Data
Aug. 25, 2016 (TW) 105127267

(51) Int. Cl. H04L 12/28; H04W 4/00

(52) U.S. Cl. CPC H04L 12/2823; H04W 84/12; H04W 4/005

(57) ABSTRACT

A LoRa mobile unit includes a main control circuit with a central processing unit, a LoRa communication module including a LoRa communication circuit electrically coupled to the central processing unit for wireless communication with an external LoRa wireless sensor network for transmitting and receiving LoRa information packets, and a wireless communication circuit electrically coupled to the central processing unit. When the LoRa communication module receives a LoRa information packet from the LoRa wireless sensor network, the central processing unit converts the LoRa information packet into a formatted information packet readable by the Bluetooth module, Wi-Fi module, mobile communication module or NFC module of the wireless communication circuit for wireless transmission to an external mobile device so that an external mobile device within the signal coverage is cable to directly access LoRa information packets.

This application claims the priority benefit of Taiwan patent application number 105127267, filed on Aug. 25, 2016.

### BACKGROUND OF THE INVENTION

### 1. Field of the Invention

The present invention relates to computer memory heating technology and more particularly, to a LoRa technology and more particularly, to a LoRa mobile unit that can receive a LoRa information packet from a LoRa wireless sensor network and then convert the LoRa information packet into a formatted information packet and transmit the formatted information packet wirelessly to a mobile device within the signal coverage, enabling a mobile device within the signal coverage of the LoRa mobile unit to directly access LoRa information packets. The invention relates also to a data transmission method used in the LoRa mobile unit.

### 2. Description of the Related Art

With popularity and rapid development of the Internet, the advent of cloud and big data applications and next-generation Internet protocol, the Internet of Things (IoT) has gained popular attention. The Internet of Things (IoT) is the internetworking of physical objects, connected security systems, thermostats, electronic appliances, lights in household and commercial environments, alarm clocks, speaker systems, vending machines, vehicles, buildings and other items-embedded with electronics, software, sensors, actuators, pet trackers, radio frequency identification systems and more that feature an IP address for internet connectivity, and the communication that occurs between these objects and other Internet-enabled devices and systems. The technology of Internet of Things (IoT) has been widely used for wisher home control, car networking, intelligent transportation, environmental monitoring and security control, urban energy and traffic management applications.

However, current applications of Internet of Things (IoT) are based on the wireless communication technology of RFID/NFC, Bluetooth, Zigbee, WLAN (wireless local area network), or mobile communication (3G,4G LTE) for data transmission. Zigbee is a wireless technology developed as an open global standard to address the unique needs of low-cost, low-power wireless M2M networks. Bluetooth is a wireless technology for exchanging data over short distances from fixed and mobile devices, and building personal area networks (PANS). Wi-Fi is a wireless networking technology that uses radio waves to provide wireless high-speed Internet and network connections. Mobile communication is the technology used for cellular communication that is practical for long distance large-scale data transmission. These wireless communication technologies can not satisfy the needs for Internet of Things (IoT) applications. Thus, some companies who believe that the Internet of Things era is now established the LoRa alliance and created Low-Power Wide-Area Network (LPWAN) of LoRa technology for long range communications at a low bit rate among things (connected objects), such as sensors operated on a battery. This standard will provide seamless interoperability among smart Things without the need of complex local installations and gives back the freedom to the user, developer, businesses enabling the roll out of Internet of Things.

Referring to FIG. 4, a LoRa wireless sensor network for the Internet of things comprises a plurality of Nodes, a plurality of gateways, a network server and a plurality of application servers. When the front end perception layer of the IoT system collected the data of an item from an end node, it can link to the back-end network server through a gateway in the network layer for data transmission, enabling collected data to be transmitted to the cloud or application server for arithmetic processing and analysis. After arithmetic processing and analysis, the result thus obtained can be provided to the application layer of the wisdom of life, green building, energy-saving wisdom, wisdom logistics, health care and industrial applications in many fields of application services. However, the current the current LoRa end node object data can only be transmitted to the back-end network server through a gateway of a public network or private networks. This communication and the transmission distance will be subject to LoRa gateway restrictions. Subject to the conditions of the transmission power and the terrain, the transmission can reach several kilometers to approximately ten kilometers of transmission distance. The LoRa nodes can only be linked with LoRa gateways. Thus, mobile devices (such as smart phones, notebook computers, tablet PCs, on-board units, etc.) can only use the built-in Wi-Fi, mobile communication interface or other wireless communication interface to connect to the network server directly or through a wireless network base station (Access Point or wireless Access Point) for object data transmission. The overall data transfer structure is not only more complex, and its application will be limited by the type and transmission distance of the wireless communication interface, causing the mobile device unable to directly access the LoRa end node for object data transmission. Further, for accessing object data, the mobile device needs to connect to the base station through the Internet, the networking cost is high. Therefore, how to solve the problem that a mobile device cannot directly connect to a LoRa node to access to object data is the direction of improvement the related industries need to achieve.

### SUMMARY OF THE INVENTION

The present invention has been accomplished under the circumstances in view. It is therefore one object of the present invention to provide a LoRa mobile unit, which allows a mobile device to directly access LoRa information packets. It is another object of the present invention to provide a data transmission method, which is practical for use in a LoRa mobile unit for allowing a mobile device to directly access LoRa information packets.

To achieve these and other objects of the present invention, a data transmission method is used in a LoRa mobile unit for enabling an external mobile device to access to a LoRa wireless sensor network for the transmission of LoRa information packet. The LoRa mobile unit comprises a main control circuit with a central processing unit, a LoRa communication module with a LoRa communication circuit electrically coupled to the central processing unit for wireless communication with an external LoRa wireless sensor network for transmitting and receiving LoRa information packets, and a wireless communication circuit consisting of a Bluetooth module, a Wi-Fi module, a mobile communication module and a NFC module respectively electrically coupled to the central processing unit. The LoRa communication module is capable of receiving a LoRa information packet from an external LoRa wireless sensor network. When the LoRa communication module receives a LoRa information packet from an external LoRa wireless sensor network, the central processing unit converts the LoRa information packet into an information packet of a predetermined format, and then wirelessly transmits the formatted said information packet to an external mobile device through the Bluetooth module, Wi-Fi module or mobile communication module of the wireless communication circuit. When the wireless communication circuit receives an information packet from an external mobile device, the central processing unit converts the received said information packet into a LoRa information packet and then drives the LoRa communication module to transmit the LoRa information packet to an external LoRa wireless sensor network wirelessly. Thus, a mobile device within the signal coverage of the LoRa mobile unit can directly access to an end node or gateway for receiving a LoRa information packet. Because the mobile device can receive a LoRa information packet without linking to the network server through the Internet, the mobile device can save the networking cost and get rid of the limitation that every end node in the LoRa wireless sensor network can simply transmit data through a gateway and the limitations of the type of wireless communication interface and the wireless communication distance.

Further, the central processing unit of the main control circuit has the universally unique identifier and RF COMM protocol function based on serial port-based simulation and adaptation LLC Agreement, enabling the Bluetooth module, the Wi-Fi module, the mobile communication module and the NFC module of the wireless communication circuit to match with respective wireless communication interfaces of external mobile devices for information packet transmission. Through the main control circuit, LoRa communication module and wireless communication circuit of the LoRa mobile unit, the mobile device can transmit an information packet to a LoRa wireless sensor network, creating a LoRa wireless communication network.

Further, in addition to the function for enabling other LoRa mobile units or mobile devices within the signal coverage for intercommunication and data exchange, in actual application, the main control circuit of the LoRa mobile unit can receive information packets from any other mobile device or LoRa mobile units, and then convert received information packets into respective LoRa information packets, and then transmit converted LoRa information packets to end nodes or gateways of the LoRa wireless sensor network, and can also transmit converted LoRa information packets to network servers through a wireless network base station, router or gateway. Thus, every mobile device can communicate with the wireless sensor network through the LoRa mobile unit of the present invention for transmitting data.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a circuit block diagram of a LoRa mobile unit in accordance with the present invention.

FIG. 2 is a circuit block diagram illustrating an application operation of the LoRa mobile unit in accordance with the present invention.

FIG. 3 is a flow chart of a data transmission method used in the LoRa mobile unit in accordance with the present invention.

FIG. 4 is a block diagram of a conventional LoRa wireless sensor network.

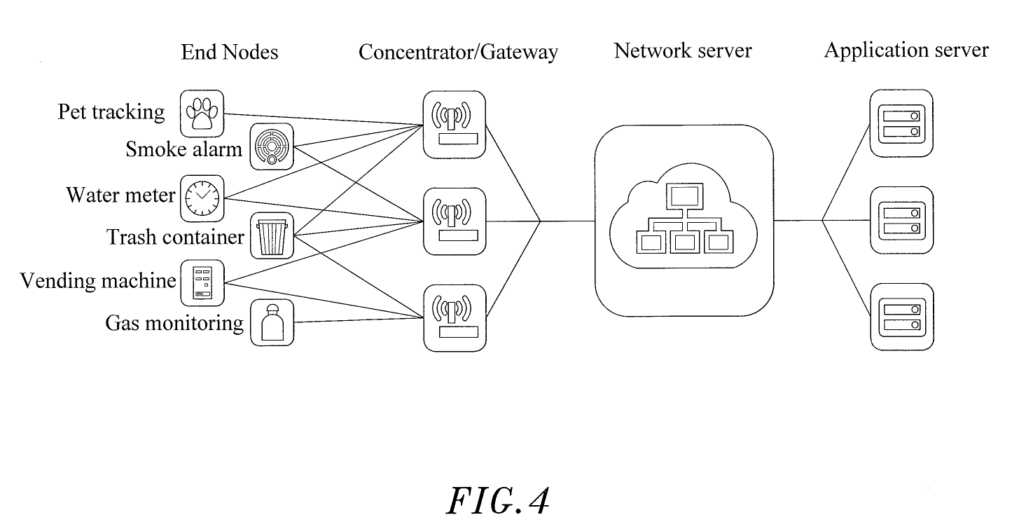

### DETAILED DESCRIPTION OF THE PREFERRED EMBODIMENT

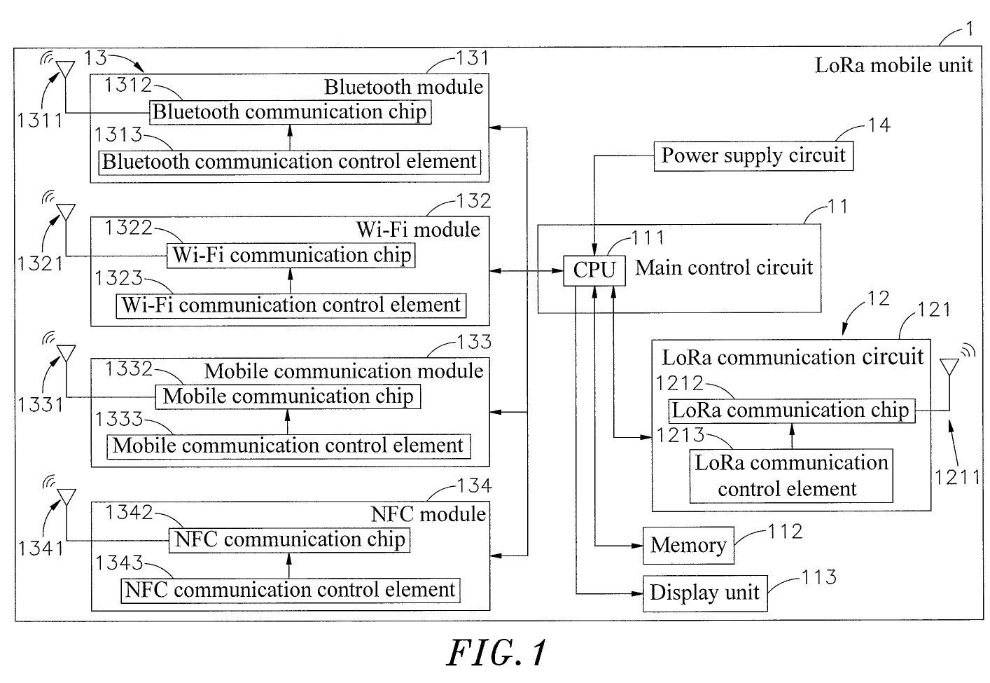

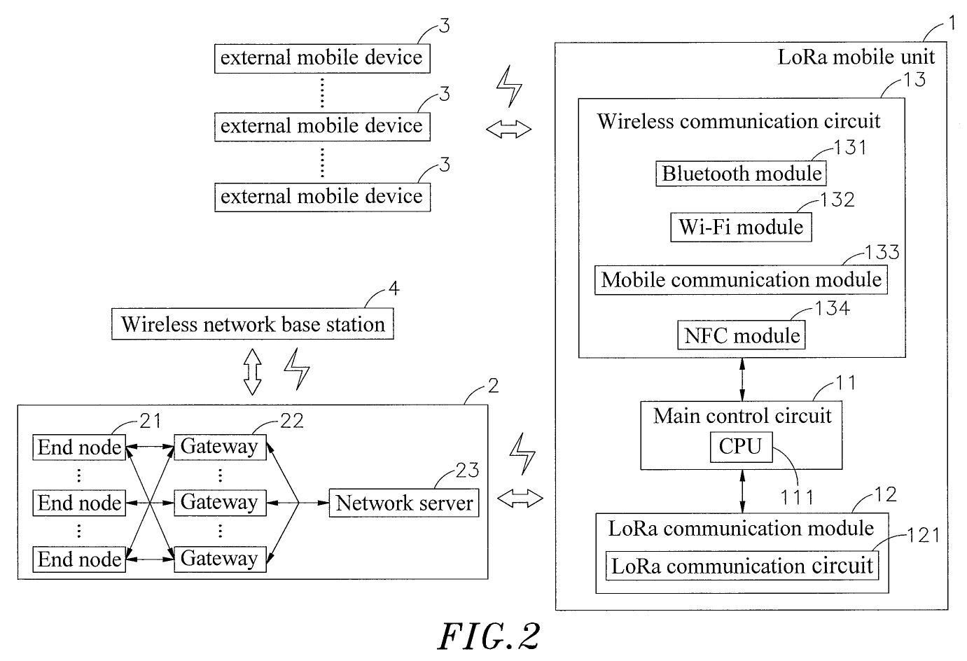

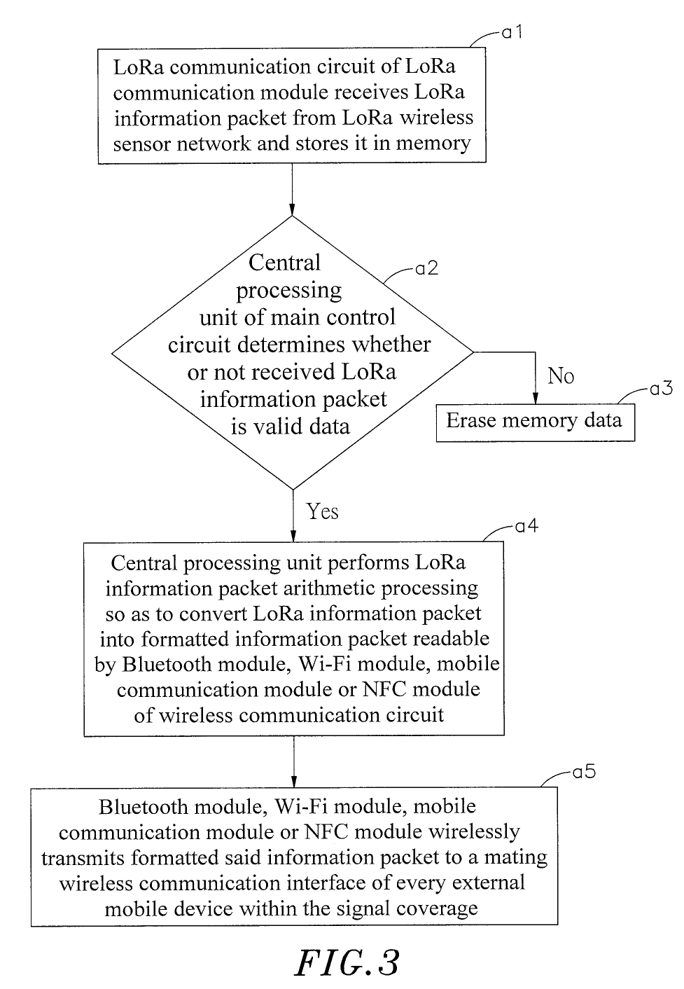

Referring to FIGS. 1-3, a circuit block diagram of a LoRa mobile unit, a circuit block diagram illustrating an application example of the LoRa mobile unit and an operation flow chart of the LoRa mobile unit are shown. As illustrated, the LoRa mobile unit 1 comprises a main control circuit 11, a LoRa communication module 12, a wireless communication circuit 13, and a power supply circuit 14. The main control circuit 11 comprises a central processing unit (CPU) 111, a memory 112 electrically coupled to the central processing unit 111 for temporarily storing information packets, and a display unit (such as display screen or LED status indicators) 113 electrically coupled to the central processing unit 111 for displaying current information packet transmission status. The LoRa communication module 12 comprises a LoRa communication circuit 121 electrically coupled to the central processing unit 111. The LoRa communication circuit 121 comprises a LoRa communication antenna 1211 and a LoRa communication chip 1212 for wireless communication with an external LoRa wireless sensor network 2 for the transmission of LoRa information packets, and a LoRa communication control element 1213 electrically coupled with the LoRa communication chip 1212 for LoRa communication control. The wireless communication circuit 13 comprises a Bluetooth module 131, a Wi-Fi module 132, a mobile communication module 133 and a NFC (Near Field Communication) module 134 electrically coupled to the central processing unit 111 of the main control circuit 11 for transmitting an information packet converted from a LoRa information packet by the central processing unit 111 to an external mobile device 3. The power supply circuit 14 can be a built-in battery, detachable battery, or attached power supply device electrically coupled to the LoRa communication module 12 and the wireless communication circuit 13 via the main control circuit 11.

Further, based on logical link control and LoRaWAN communication protocol, the central processing unit 111 of the main control circuit 11 supports three difference classes of operation: Bi-directional end-devices (Class A); Bi-directional end-devices with scheduled receive slots (Class B); and Bi-directional end-devices with maximal receive slots (Class C) for communication with other LoRa units for the transmission of messages and LoRaWAN information packets, enabling the Bluetooth module 131, Wi-Fi module 132, mobile communication module 133 and NFC module 134 of the wireless communication circuit 13 to match with respective wireless communication interfaces of every external mobile device 3 for information packet transmission. In actual application, the central processing unit 111 of the main control circuit 11 or the Bluetooth module 131, Wi-Fi module 132, mobile communication module 133 and NFC module 134 of the wireless communication circuit 13 have an information converting circuit (not shown) electrically connected thereto. The information converting circuit has a LoRaWAN information packet conversion function so that the wireless communication circuit 13 can be interlinked with every external mobile device 3. On the contrary, every mobile device 3 can transmit an information packet to the LoRa mobile unit 1, enabling the information packet to be converted to a LoRa information packet by the main control circuit 11 for transmission through the LoRa communication module 12 and wireless communication circuit 13 to the LoRa wireless sensor network 2.

Further, the Bluetooth module 131 of the wireless communication circuit 13 comprises a Bluetooth communication antenna 1311 and a Bluetooth communication chip 1312 for wireless communication with an external mobile device 3 for transmitting and receiving Bluetooth information packets, and a Bluetooth communication control element 1313 electrically coupled with the Bluetooth communication chip 1312 for wireless Bluetooth communication control. Similarly, the Wi-Fi module 132 of the wireless communication circuit 13 comprises a Wi-Fi communication antenna 1321 and a Wi-Fi communication chip 1322 for wireless communication with an external mobile device 3 for transmitting and receiving Wi-Fi information packets, and a Wi-Fi communication control element 1323 electrically coupled with the Wi-Fi communication chip 1322 for Wi-Fi communication control. Further, the mobile communication module 133 can be a 2G, 2.5G, 3G, 3.5G or 4G LTE wireless communication interface, comprising a mobile communication antenna 1331 and a mobile communication chip 1332 for wireless communication with an external mobile device 3 for transmitting and receiving 2G, 2.5G, 3G, 3.5G or 4G LTE wireless information packets, and a mobile communication control element 1333 electrically coupled with the mobile communication chip 1332 for 2G, 2.5G, 3G, 3.5G or 4G LTE wireless communication control. The NFC module 134 comprises a NFC communication antenna 1341 and a NFC communication chip 1342 for wireless communication with an external mobile device 3 for transmitting and receiving NFC wireless information packets, and a NFC communication control element 1343 electrically coupled with the NFC communication chip 1342 for NFC communication control. Further, the aforesaid LoRa wireless sensor network 2 comprises a plurality of end nodes 21 and gateways 22 for the transmission of LoRa information packets between the LoRa mobile unit and a wireless network base station 4, and a network server 23 and a plurality of application servers for arithmetic processing and data analysis.

The invention also provides a data transmission method for use in the LoRa mobile unit 1 for enabling an external mobile device 3 to access to the LoRa wireless sensor network 2 for the transmission of LoRa information packets. The data transmission method comprises the steps of:

(a1) Enable the LoRa communication circuit 121 of the LoRa communication module 12 to receive a LoRa information packet from the LoRa wireless sensor network 2 and then to store the LoRa information packet in the memory 112 of the main control circuit 11.

(a2) Enable the central processing unit 111 of the main control circuit 11 to determine, according to pre-determined settings, whether or not the said LoRa information packet is a valid data, and then proceed to step (a4) if the said LoRa information packet is a valid data, or step (a3) if not.

(a3) Erase the data of the memory 112.

(a4) Enable the central processing unit 111 to perform LoRa information packet arithmetic processing so as to demodulate the said LoRa information packet and then modulate it into a formatted information packet readable by the Bluetooth module 131, Wi-Fi module 132, mobile communication module 133 or NFC module 134 of the wireless communication circuit 13, and then proceed to step (a5).

(a5) Enable the Bluetooth module 131, Wi-Fi module 132, mobile communication module 133 or NFC module 134 to wirelessly transmit the formatted information packet to a mating wireless communication interface of any external mobile device 3 within the signal coverage or the network server 23 of the network server 23 of the LoRa wireless sensor network 2, or to wirelessly transmit the formatted information packet to a mating wireless communication interface of any external mobile device 3 beyond the signal coverage or the network server 23 of the network server 23 of any other LoRa wireless sensor network 2 via the wireless network base station 4 or a router or gateway.

Thus, by means of the LoRa communication circuit 121, the LoRa communication module 12 of the LoRa mobile unit 1 can receive a LoRa information packet from the end nodes 21 and gateways 22 of the LoRa wireless sensor network 2, and then store the LoRa information packet in the memory 112 of the main control circuit 11, and at the same time, the display unit 113 of the main control circuit 11 of the LoRa mobile unit 1 can indicate the current LoRa information packet transmission status. When the central processing unit 111 of the main control circuit 11 determined the received LoRa information packet to be invalid packet after through an analysis and logic management computing according to predetermined conditions, the central processing unit 111 immediately erases the data of the memory 112. When the central processing unit 111 of the main control circuit 11 determined the received LoRa information packet to be valid packet, the central processing unit 111 immediately converts the LoRa information packet into a Bluetooth, Wi-Fi, Mobile communication or NRFF information packet readable by the Bluetooth module 131, Wi-Fi module 132, mobile communication module 133 or NFC module 134 of the wireless communication circuit 13.

Thereafter, the Bluetooth module 131, Wi-Fi module 132, mobile communication module 133 or NFC module 134 of the wireless communication circuit 13 transmits the information packet wirelessly to the mating wireless communication interface of every mobile device 3 (such as smart phone, notebook computer, tablet computer, on-board unit, etc.) in the signal coverage, achieving the control and management of end nodes 21. Further, after the information packet is converted into a LoRa information packet, the LoRa information packet can be transmitted wirelessly to the network server 23 of the LoRa wireless sensor network 2. Further, the collected information packets can also be directly transmitted through a wireless network base station 4, router or gateway to the network server 23 for computation and analysis without conversion, so that the computed and analyzed data can be provided for back-end applications and services in multiple fields (such as cloud computing, big data analysis, etc.). Thus, the LoRa mobile unit 1 can receive a LoRa information packet from an end node 21 or gateway 22 of the LoRa wireless sensor network 2 and convert the received LoRa information packet into an information packet readable by a mobile device 3 so that a mobile device 3 within the signal coverage of the LoRa mobile unit 1 can directly access to an end node nodes 21 or gateway 22 for receiving a LoRa information packet. Because the mobile device 3 can receive a LoRa information packet without linking to the network server 23 through the Internet, wireless network base station 4 or other network equipment, the mobile device 3 can save the networking cost and get rid of the limitation that every end node 21 in the LoRa wireless sensor network 2 can simply transmit data through a gateway 22 and the limitations of the type of wireless communication interface and the wireless communication distance, demonstrating the practicality and applicability of using LoRa mobile device 1 of the present invention.

As stated above, the LoRa mobile unit 1 can receive a LoRa information packet from an end node 21 or gateway 22 of the LoRa wireless sensor network 2 by means of the LoRa communication module 12, enabling the received LoRa information packet to be converted by the main control circuit 11 into a formatted information packet for wireless transmission by the wireless communication circuit 13 to every other LoRa mobile unit 1 or mobile device 3 within the signal coverage. In actual application, the LoRa mobile unit 1 can use the wireless communication circuit 13 to receive an information packet from an external mobile device 3 or other LoRa mobile unit 1 within the signal coverage, enabling the received information packet to be converted by the main control circuit 11 into a LoRa information packet for wireless transmission by the LoRa communication module 12 to every end node 21 or gateway 22 within the signal coverage of the LoRa wireless sensor network 2. The LoRa information packet can also be transmitted wirelessly by the LoRa communication module 12 to the network server 23 of the LoRa wireless sensor network 2 via a wireless network base station 4, router or gateway, enabling every mobile device 3 within the signal coverage to intercommunicate with the wireless sensor network 2 via the LoRa mobile unit 1.

In conclusion, the LoRa communication module 12 of the LoRa mobile unit 1 is designed for receiving a LoRa information packet from an end node 21 or gateway 22 of the LoRa wireless sensor network 2, enabling the received LoRa information packet to be converted by the main control circuit 11 into a formatted information packet readable by a mobile device 3, so that the formatted information packet can then be wirelessly transmitted by the Bluetooth module 131, Wi-Fi module 132, mobile communication module 133 or NFC module 134 of the wireless communication circuit 13 to a mobile device 3 within the signal coverage. Thus, any mobile device 3 within the signal coverage of the LoRa mobile unit 1 can directly access LoRa information packets without linking to the Internet, saving the networking cost and getting rid of the limitation that every end node in the LoRa wireless sensor network 2 can simply transmit data through a gateway 22.

Although a particular embodiment of the invention has been described in detail for purposes of illustration, various modifications and enhancements may be made without departing from the spirit and scope of the invention. Accordingly, the invention is not to be limited except as by the appended claims.

1. A LoRa mobile unit, comprising:
a main control circuit comprising a central processing unit;
a LoRa communication module comprising a LoRa communication circuit electrically coupled to said central processing unit for wireless communication with an external LoRa wireless sensor network for transmitting and receiving LoRa information packets; and
a wireless communication circuit comprising a Bluetooth module, a Wi-Fi module, a mobile communication module and a NFC module respectively electrically coupled to said central processing unit;
wherein when said LoRa communication module receives a LoRa information packet from an external LoRa wireless sensor network, said central processing unit converts said LoRa information packet into an information packet of a predetermined format and then wirelessly transmits the formatted said information packet to an external mobile device through said wireless communication circuit; when said wireless communication circuit receives an information packet from an external mobile device, said central processing unit converts the received said information packet into a LoRa information packet and then drives said LoRa communication circuit to transmit said LoRa information packet to an external LoRa wireless sensor network wirelessly.

2. The LoRa mobile unit as claimed in claim 1, wherein based on logical link control and LoRaWAN communication protocol, said central processing unit of said main control circuit supports three difference classes of operation: Bi-directional end-devices (Class A); Bi-directional end-devices with scheduled receive slots (Class B); and Bi-directional end-devices with maximal receive slots (Class C) for communication with external LoRa devices for the transmission of wireless messages and LoRaWAN information packets, enabling said Bluetooth module, said Wi-Fi module, said mobile communication module and said NFC module of said wireless communication circuit to match with respective wireless communication interfaces of external mobile devices for information packet transmission.

3. The LoRa mobile unit as claimed in claim 1, wherein said main control circuit further comprises a memory electrically coupled to said central processing unit for temporarily storing information packets.

4. The LoRa mobile unit as claimed in claim 1, wherein said main control circuit further comprises a display unit electrically coupled to said central processing unit for displaying current information packet transmission status.

5. The LoRa mobile unit as claimed in claim 1, further comprising a power supply circuit electrically coupled to said main control circuit, said LoRa communication module and said wireless communication circuit.

6. The LoRa mobile unit as claimed in claim 1, wherein said LoRa communication module comprises a LoRa communication circuit electrically coupled to said central processing unit, said communication circuit comprising a LoRa communication antenna and a LoRa communication chip for wireless communication with an external LoRa wireless sensor network for the transmission of LoRa information packets and a LoRa communication control element electrically coupled with said LoRa communication chip for LoRa communication control.

7. The LoRa mobile unit as claimed in claim 1, wherein said Bluetooth module of said wireless communication circuit comprises a Bluetooth communication antenna and a Bluetooth communication chip for wireless communication with an external mobile device for transmitting and receiving Bluetooth information packets, and a Bluetooth communication control element electrically coupled with said Bluetooth communication chip for wireless Bluetooth communication control.

8. The LoRa mobile unit as claimed in claim 1, wherein said Wi-Fi module of said wireless communication circuit comprises a Wi-Fi communication antenna and a Wi-Fi communication chip for wireless communication with an external mobile device for transmitting and receiving Wi-Fi information packets, and a Wi-Fi communication control element electrically coupled with said Wi-Fi communication chip for wireless Wi-Fi communication control.

9. The LoRa mobile unit as claimed in claim 1, wherein said mobile communication module of said wireless communication circuit is a 2G, 2.5G, 3G, 3.5G or 4G LTE wireless communication interface, comprising a mobile communication antenna and a mobile communication chip for wireless communication with an external mobile device for transmitting and receiving 2G, 2.5G, 3G, 3.5G or 4G LTE wireless information packets, and a mobile communication control element electrically coupled with said mobile communication chip for 2G, 2.5G, 3G, 3.5G or 4G LTE wireless communication control.

10. The LoRa mobile unit as claimed in claim 1, wherein said NFC module of said wireless communication circuit comprises a NFC communication antenna and a NFC communication chip for wireless communication with an external mobile device for transmitting and receiving NFC wireless information packets, and a NFC communication control element electrically coupled with said NFC communication chip for NFC communication control.

11. A data transmission method used in the LoRa mobile unit as claimed in claim 1 for enabling an external mobile device to access to a LoRa wireless sensor network for the transmission of a LoRa information packet, comprising the steps of:
(a1) enabling the LoRa communication circuit of the LoRa communication module of the said LoRa mobile unit to receive a LoRa information packet from said LoRa wireless sensor network and then to store the received said LoRa information packet in the memory of the main control circuit of the said LoRa mobile unit;
(a2) enabling the central processing unit of the main control circuit of the said LoRa mobile unit to determine, according to pre-determined settings, whether or not the received said LoRa information packet is a valid data, and then proceed to step (a4) if the received said LoRa information packet is a valid data, or step (a3) if not;
(a3) erasing the data of the memory of the main control circuit of the said LoRa mobile unit;
(a4) enabling the central processing unit of the main control circuit of the said LoRa mobile unit to perform LoRa information packet arithmetic processing so as to demodulate the received said LoRa information packet and then modulate the received said LoRa information packet into a formatted information packet readable by the Bluetooth module, Wi-Fi module, mobile communication module or NFC module of the wireless communication circuit of the said LoRa mobile unit, and then proceed to step (a5).
(a5) enabling the Bluetooth module, Wi-Fi module, mobile communication module or NFC module of the wireless communication circuit of the said LoRa mobile unit to wirelessly transmit the formatted said information packet to a mating wireless communication interface of an external mobile device within the signal coverage.

12. The data transmission method as claimed in claim 11, wherein said step (a5) further comprises a sub step of enabling the Bluetooth module, Wi-Fi module, mobile communication module or NFC module of the wireless communication circuit of the said LoRa mobile unit to wirelessly transmit the formatted said information packet to the network server of the said LoRa wireless sensor network, or to wirelessly transmit the formatted said information packet to a mating wireless communication interface of an external mobile device beyond the signal coverage or the network server of the network server of other external LoRa wireless sensor networks via a wireless network base station or a router or gateway

13. The data transmission method as claimed in claim 11, wherein said step (a5) further comprises a sub step of enabling the Bluetooth module, Wi-Fi module, mobile communication module or NFC module of the wireless communication circuit of the said LoRa mobile unit to wirelessly transmit the formatted said information packet to other LoRa mobile units or mobile devices for intercommunication.

14. The data transmission method as claimed in claim 11, wherein the main control circuit of the said LoRa mobile unit further comprises a display unit electrically coupled to said central processing unit for displaying current information packet transmission status.
